(19) United States
(12) Patent Application Publication
(10) Pub. No.: US 2023/0084995 A1
(43) Pub. Date: Mar. 16, 2023

(54) METHOD FOR MAKING A FILTER ELEMENT OR MOUTHPIECE

(71) Applicant: Essentra Filter Products Development Co. Pte. Ltd., Singapore (SG)

(72) Inventors: Amanda PERIMAN, Kernersville, NC (US); Nortee LOUDER, Greensboro, NC (US); Philip MAYNARD, Archdale, NC (US); Sudirman WIDIARTO, Sidoarjo (ID); Elizabeth GERRINGER, Singapore (SG)

(21) Appl. No.: 17/801,850

(22) PCT Filed: Feb. 26, 2021
(86) PCT No.: PCT/GB2021/050501

§ 371 Date: Aug. 24, 2022

Related U.S. Application Data
(60) Provisional application No. 62/982,426, filed on Feb. 27, 2020.

(30) Foreign Application Priority Data
Jun. 22, 2020 (GB) 2009509.7

(51) Int. Cl. A24D 3/14; A24D 3/02; A24D 3/04; A24D 3/10; B31D 5/00

(52) U.S. Cl. CPC A24D 3/14; A24D 3/0237; A24D 3/048; A24D 3/022; A24D 3/10; A24D 3/0279; B31D 5/0082

(57) ABSTRACT

There is disclosed a method of making a filter element or mouthpiece (300) comprising the steps of: advancing filtering material in the longitudinal direction; drawing the advancing filtering material into a shaping element (110), to thereby form a longitudinally extending rod of filtering material comprising a channel extending longitudinally through the rod of filtering material; wherein the shaping element (110) comprises a chamber and a shaping rod (200) which extends longitudinally within the chamber, the inner surface of the chamber shaping the advancing filtering material to form the longitudinally extending rod of filtering material, and the shaping rod (200) shaping the advancing filtering material to form the channel extending longitudinally through the rod of filtering material; and wherein the shaping element (110) applies an additive to the filtering material.

The present invention relates to mouthpieces, filter elements and filters, along with methods for making these, and an apparatus used to make the filter elements or mouthpieces.

Tube filter elements and tube mouthpieces for smoking articles are well known in the art. Typically, a tube filter element or mouthpiece includes a cylindrical core of filtering material which includes a channel that extends longitudinally from an end of the cylindrical core. A tube filter element is often included as part of a multi segment filter and the tube filter element is usually positioned at the mouth end of the filter to provide a distinctive end appearance which may be useful for anti-counterfeiting purposes.

The presence of an additive, such as a flavouring agent, in a tobacco smoke filter is well known in the art. Typically, a flavouring agent is not incorporated directly into a tube filter element because of difficulty introducing the flavouring agent into the filtering material and difficulties in retaining the flavouring agent in the filtering material. Tube filter elements often form part of a multi segment filter, in which a further filter element carries out additional filtration or includes an additive such as a flavouring agent.

Applying an additive, such as a flavouring agent, after the filter element has been shaped can lead to contamination problems arising from the wet filter. Additionally, applying a flavouring agent in this way can lead to unacceptable odour and impact on air quality in the vicinity of the production line.

Thus, there is a need for a tube filter element or mouthpiece which includes an additive such as a flavouring agent, so that an additional filter element is not required to provide additive to a tube filter or mouthpiece.

In an aspect of the present invention, there is provided a method of making a filter element or mouthpiece comprising the steps of: advancing filtering material in a longitudinal direction; drawing the advancing filtering material into a shaping element, to thereby form a longitudinally extending rod of filtering material comprising a channel extending longitudinally through the rod of filtering material; wherein the shaping element comprises a chamber and a shaping rod (mandrel) which extends longitudinally within the chamber, the inner surface of the chamber shaping the advancing filtering material to form the longitudinally extending rod of filtering material, and the shaping rod shaping the advancing filtering material to form the channel extending longitudinally through the rod of filtering material; and wherein the shaping element applies an additive to the filtering material.

The applicant has found that the methods of the present invention enable an additive to be applied directly to the filtering material which forms the filter element or mouthpiece. The applicant has found that the majority of the additive applied to the filtering material remains intact after the filter element or mouthpiece is made. The applicant has found that filter elements or mouthpieces which are made according to the process of the invention demonstrate excellent additive loading, and demonstrate an additive level that is maintained long after filter element/mouthpiece production. This means that a tube filter or mouthpiece can be provided which does not require additional filter elements in order to, for example, impart flavour to the smoke produced by a smoking article. Additionally, by applying the additive within the shaping element, the additive is easily contained within a small space, so there is no impact on air quality in the vicinity of the filter/mouthpiece making apparatus, and there is no noticeable odour associated with the additive.

The shaping rod may also be referred to as a mandrel.

The filtering material may be continuously advancing filtering material.

Preferably, the additive is applied by the shaping rod.

The shaping rod may comprise a cavity and a plurality of apertures which are coupled to the cavity, wherein the additive travels from the cavity and exits the shaping rod through the plurality of apertures as the advancing filtering material passes through the shaping element. The plurality of apertures may be a plurality of holes or slits. Preferably, the plurality of apertures may be a plurality of holes. The shaping rod may include between 4 and 24 holes, for example between 8 and 24 holes, for example between 12 and 24 holes, for example between 16 and 24 holes, for example between 20 and 24 holes, for example 24 holes. The holes may be evenly spaced around the circumference of the shaping rod. The shaping rod may include one, two, three or four sets of six holes that are evenly spaced around the circumference of the shaping rod.

The shaping rod may comprise an outer surface which defines the shape of the channel extending longitudinally though the rod of filtering material. The inner surface of the shaping element chamber shapes the filtering material as it passes through the shaping element to thereby define the shape (for example a cylinder) of the longitudinally extending rod. The advancing filtering material surrounds the shaping rod as it advances through the shaping element chamber. The filtering material is forced between the inner surface of the chamber and the outer surface of the shaping rod. The shaping rod thereby forms a longitudinally extending channel inside the longitudinally extending rod of filtering material.

The plurality of apertures (e.g. holes) may be located in the outer surface of the shaping rod.

The cavity may be a channel which is defined by an inner surface of the shaping rod. The channel being coupled to the plurality of holes such that the additive may travel from the channel and exit the shaping rod through the plurality of holes located in the outer surface of the shaping rod.

The shaping rod may, for example, have a substantially circular cross section, an oval cross section, a triangular cross section, a trilobal cross section or a star shaped cross section. It will be appreciated that the shape of the shaping rod determines the shape of the channel that is formed in the rod of filtering material. Thus, a shaping rod having, for example, a circular cross section will produce a channel having a circular cross section.

The shaping rod may have a diameter from 0.5 mm to 10 mm, for example from 1 mm to 8 mm, for example from 1 mm to 4 mm, for example from 4 mm to 8 mm, for example from 3 mm to 6 mm. It will be appreciated that the diameter of the shaping rod will determine the diameter of the channel.

The inner surface of the chamber may define a hollow shape which is substantially cylindrical. It will be appreciated that the inner surface of the chamber will define the outer shape of the longitudinally extending rod of filtering material, and therefore the overall shape of the finished mouthpiece or filter element. For example, an inner surface of the chamber which defines a cylinder will form a rod of filtering material that is substantially cylindrical.

The inner surface of the chamber may have a circumference of between 14 mm and 27 mm. It will be appreciated that the inner circumference of the chamber may define the outer circumference of the longitudinally extending rod of filtering material.

The filtering material may be drawn from a source before being advanced towards the shaping element.

Preferably, a plasticiser is applied to the advancing filtering material.

The plasticiser may be applied to the advancing filtering material before the advancing filtering material is drawn into the shaping element. For example, a plasticiser may be applied to the filtering material at a plasticising station before the filtering material enters the shaping element. The plasticiser may be sprayed onto the filtering material, for example on to the outer surface of the filtering material. Alternatively, plasticiser may have previously been applied to the filtering material via a separate and discrete process. The plasticiser may be triacetin, triethyleneglycol diacetate (TEGDA) or polyethylene glycol (PEG).

The plasticiser may be applied in an amount such that the filtering material includes from 8% to 24% by weight of the filtering material and plasticiser, for example about 12% to 24%, for example about 14% to 22%, for example about 16% to 20%, for example about 17 to 19%, for example about 18% of the weight of the filtering material and plasticiser.

The amount of plasticiser present in the filtering material is calculated as a percentage of the total weight of the filtering material and plasticiser via the general equation presented below.

$$Percentage of plasticiser \% = \frac{amount of plasticiser ( g )}{amount of plasticiser ( g ) + amount of filtering material ( g )} \times 100$$

The addition of a plasticiser to the filtering material causes the filtering material to harden, which may improve the shape definition of the filter element or mouthpiece, and in particular the shape definition of the channel.

Preferably, steam is applied to the advancing filtering material as it passes through the shaping element. The steam may be applied directly to the advancing filtering material within the shaping element. The steam may be superheated steam. The shaping element may include steam inlets to enable steam (e.g. superheated steam) to travel into the shaping element and directly contact the filtering material as it is shaped. The steam has the effect of curing the filtering material as it is shaped. The steam may be applied directly to the outer surface of the longitudinally extending rod of filtering material as it forms within the shaping element.

Preferably, the additive is a liquid. The additive may form a spray as it exits the plurality of apertures. For example, the additive may be pumped under pressure from the cavity or channel through the apertures, such that the additive exits the shaping rod as a spray. Herein the term spray means a dynamic collection of liquid droplets dispersed in a gas.

Surprisingly, the applicant has found that despite the additive being applied in the presence of steam, high additive loadings, for example flavouring agent loadings, can be achieved in the final product. While not wishing to be bound by theory, it is hypothesised that because the additive is applied within the shaping element, which confines the filtering material and additive, the additive is less susceptible to loss by evaporation. Additionally, it is hypothesised that applying the additive when the filtering material is shaped enables the additive to penetrate into the filtering material and in the case of fibrous filtering material, coat the individual fibres.

Preferably, the additive is a smoke or aerosol modifying agent, for example a smoke modifying agent. The smoke or aerosol modifying agent may include a flavouring agent. Examples, of suitable flavouring agents include menthol, spearmint, clove, nutmeg, cinnamon, lemon, chocolate, peach, strawberry, vanilla and the like. The flavouring agent may be a liquid composition which includes only the flavouring agent, or the liquid composition may further comprise a liquid carrier such as an alcohol, for example propylene glycol, or other organic solvent.

In the case of the additive being a flavouring agent, the flavouring agent is applied such that the final filter element or mouthpiece has a flavouring agent loading of from 1 mg per filter element/mouthpiece to 30 mg per filter element/mouthpiece, for example from 2 mg per filter element/mouthpiece to 25 mg per filter element/mouth piece, for example from 2 mg per filter element/mouthpiece to 20 mg per filter element/mouthpiece, for example from 2 mg per filter element/mouthpiece to 10 mg per filter element/mouthpiece, for example from 2 mg per filter element/mouthpiece to 8 mg per filter element/mouthpiece, for example from 4 mg per filter element/mouthpiece to 8 mg per filter element/mouthpiece, for example 6 mg per filter element/mouth piece.

The filtering material may be, for example, any of those materials (usually filamentary, fibrous, web or extruded) conventionally employed for tobacco smoke filter manufacture. The filtering material may be natural or synthetic filamentary tow, e.g. of cotton or plastics such as polyethylene or polypropylene, or cellulose acetate filamentary tow. The filtering material may be a thermoplastic or otherwise spinnable polymer, for example polypropylene, polyethylene terephthalate or polylactide. It may be, for example, natural or synthetic staple fibres, cotton wool, web material such as paper (usually creped) and synthetic non-wovens, and extruded material (e.g. starch, synthetic foams). Preferably the filtering material comprises cellulose acetate filamentary tow.

The filtering material may optionally include a binder material. The filtering material may optionally include a water soluble binder material. Examples of water soluble binder materials include water soluble polymer materials such as polyvinyl alcohol, polyvinyl pyrrolidone, polyvinyl ether, starches, polyethylene glycols and polypropylene glycols; blends of water soluble binders with plasticisers such as triacetin, triethyleneglycol diacetate (TEGDA), or polyethylene glycol (PEG); and hot melt water soluble binders in particulate form. The inclusion of a water soluble binder material may further enhance the ability of the filter element or mouthpiece formed by the process of the invention to be readily and swiftly degraded, e.g. under environmental conditions.

In the case of the filtering material being filamentary tow, this may be drawn from two sources, such as two bales of filamentary tow. The tow may be drawn from each bale and then spread transversely, before a plasticiser is applied to the surface of the tow fibres. Transverse spreading of the tow increases the available surface area for plasticiser application.

After the plasticiser is applied, the tow may be gathered before entering the shaping element.

The method may further comprise a step in which the longitudinally extending rod of filtering material is cooled after exiting the shaping element. The cooling may be carried out by one or more jets of air directed at the longitudinally extending rod of filtering material.

The method may further comprise a step in which the longitudinally extending rod of filtering material is wrapped, for example with a paper material such as a plug wrap. The longitudinally extending rod of filtering material may be wrapped after the cooling step.

The method may further comprise a step wherein the longitudinally extending rod of filtering material is cut to form a filter element or mouthpiece. The longitudinally extending rod of filtering material may be cut using standard cutting methods known in the art, such as a rotating drum cutter. The cutting step may take place after the longitudinally extending rod of filtering material is cooled.

In a further aspect of the present invention, there is provided a filter element or mouthpiece formed by the method according to any statement set out above.

In a further aspect of the present invention, there is provided a shaping rod for use in a method of making a filter element or mouthpiece comprising: a longitudinal rod comprising a cavity and an outer surface; a plurality of apertures located in the outer surface of the longitudinal rod, wherein the plurality of apertures are coupled to the cavity.

The cavity may be in the form of a channel, for example a cylindrical channel, which is defined by an inner surface of the shaping rod.

The plurality of apertures may extend from the outer surface of the shaping rod to the cavity or channel.

The plurality of apertures may comprise a plurality of holes or slits, preferably a plurality of holes.

The shaping rod may include between 4 and 24 holes, for example between 8 and 24 holes, for example between 12 and 24 holes, for example between 16 and 24 holes, for example between 20 and 24 holes, for example 24 holes. The holes may be evenly spaced around the circumference of the shaping rod. The shaping rod may include one, two, free or four sets of six holes that are evenly spaced around the circumference of the shaping rod.

The shaping rod may be made from a metal such as brass or stainless steel. The shaping rod may have for example, a circular cross section, an oval cross section, a triangular cross section, a trilobal cross section or a star shaped cross section. It will be appreciated that the shape of the shaping rod determines the shape of the channel that is formed in the rod of filtering material. Thus, a shaping rod having, for example, a circular cross section will produce a channel having a circular cross section.

In a further aspect of the present invention there is provided an apparatus for making a filter element or mouthpiece, the apparatus comprising: a shaping element comprising a chamber and a shaping rod according to the invention, wherein the shaping rod extends longitudinally within the chamber.

The chamber may have an inner surface which is configured to shape filtering material to thereby form a longitudinally extending rod of filtering material. The shaping rod may be configured to shape filtering material to form a channel extending longitudinally through the rod of filtering material. The chamber and shaping rod may together be configured to form a longitudinally rod of filtering material including a channel extending longitudinally there through. The shaping rod may be configured to apply an additive, such as a flavouring agent, to the filtering material within the chamber. The shaping rod may be configured apply additive in the form of a spray. The chamber may comprise an inner surface which defines a hollow cylinder.

The chamber may include one or more steam inlets which are configured to enable steam, such as superheated steam, to enter the chamber. The or each steam inlet may be configured to apply, for example directly apply, the steam or superheated steam to filtering material within the chamber. The or each steam inlet may be configured to directly apply the steam or superheated steam to the outer surface of the longitudinally extending rod of filtering material as it forms within the shaping element.

The shaping rod may be aligned centrally within the chamber. Central alignment of the shaping rod means that the channel formed in the longitudinally extending rod of filtering material is positioned centrally within the longitudinally extending rod of filtering material.

The shaping rod may be connected to an additive reservoir. The apparatus may further comprise a pump for pumping the additive from the additive reservoir to the shaping rod.

The apparatus may further comprise one or more of a plasticising station configured to apply or for applying plasticiser to the filtering material, and a cutting element configured to cut or for cutting the longitudinally extending rod of filtering material.

The apparatus may further comprise a wrapping element configured to wrap or for wrapping the longitudinally extending rod of filtering material prior to cutting.

In a further aspect of the present invention, there is provided a filter element or mouthpiece comprising: a longitudinally extending core of filtering material, wherein the longitudinally extending core of filtering material has an outer surface and an inner surface; a channel extending from an end of the core, wherein the channel is defined by the inner surface of the core; and a layer of additive disposed on the inner surface of the core.

The longitudinally extending core of filtering material may have a substantially circular or oval transverse cross section. Preferably, the longitudinally extending core has a substantially circular transverse cross section, for example a circular transverse cross section. It will be appreciated that a substantially circular transverse cross section will amount to a substantially cylindrical core.

The channel may extend through part of the length of the longitudinally extending core or through the entire length of the longitudinally extending core.

The channel may have a substantially circular transverse cross section, an oval transverse cross section, a triangular transverse cross section, a trilobal transverse cross section or a star shaped transverse cross section.

The filtering material may be, for example, any of those materials (usually filamentary, fibrous, web or extruded) conventionally employed for tobacco smoke filter manufacture. The filtering material may be natural or synthetic filamentary tow, e.g. of cotton or plastics such as polyethylene or polypropylene, or cellulose acetate filamentary tow. The filtering material may be a thermoplastic or otherwise spinnable polymer, for example polypropylene, polyethylene terephthalate or polylactide. It may be, for example, natural or synthetic staple fibres, cotton wool, web material such as paper (usually creped) and synthetic non-wovens, and extruded material (e.g. starch, synthetic foams). Preferably the filtering material comprises cellulose acetate filamentary tow.

The filtering material may optionally include a binder material. The filtering material may optionally include a water soluble binder material. Examples of water soluble binder materials include water soluble polymer materials such as polyvinyl alcohol, polyvinyl pyrrolidone, polyvinyl ether, starches, polyethylene glycols and polypropylene glycols; blends of water soluble binders with plasticisers such as triacetin, triethyleneglycol diacetate (TEGDA), or polyethylene glycol (PEG); and hot melt water soluble binders in particulate form. The inclusion of a water soluble binder material may further enhance the ability of the filter element or mouthpiece formed by the process of the invention to be readily and swiftly degraded e.g. under environmental conditions.

The total denier of the filtering material may be from around 12,000 to 100,000 g per 9000 m, for example 20,000 to 80,000 g per 9000 m, for example 20,000 to 50,000 g per 9000 m.

In the case of the filtering material being formed from a single bale of tow, the total denier of the filtering material may be from around 12,000 to 50,000 g per 9000 m for example from 30,000 g to 40,000 g per 9000 m, for example from 30,000 g to 38,000 g per 9000 m, for example 30,000 g, 32,000 g, 33,000 g, 37,000 g or 40,000 g per 9000 m.

In the case of the filtering material being formed from two bales of tow, the total denier of the filtering material may be from around 20,000 to 100,000 g per 9000 m for example from 60,000 g to 80,000 g per 9000 m, for example from 60,000 g to 76,000 g per 9000 m, for example 60,000 g, 64,000 g, 66,000 g, 74,000 g or 80,000 g per 9000 m.

The filament denier may be from 1.5 g to 12 g per 9000 m, for example from 1.5 g to 9 g per 9000 m, for example 5 g, 7.3 g, 8 g or 9.0 g per 9000 m.

Filtering material is typically described by reference to the filament denier, the total denier and the fibre cross section. For example, the filtering material may comprise tow having the following denier: 8.0Y40, 8.0Y32, 7.3Y33, or 9.0Y37. For example, filtering material having a denier of 8.0Y40 means that the filament denier is 8.0 g per 9000 m, the total denier is 40000 g per 9000 m and the filaments have a Y shaped cross section.

The filtering material may comprise a plasticiser. The filtering material may include a plasticiser in an amount of from about 8% to 24% by weight of the filtering material and plasticiser, for example from about 12% to 24%, for example from about 14% to 22%, for example from about 16% to 20%, for example from about 17 to 19%, for example about 18% of the weight of the filtering material and plasticiser.

The amount of plasticiser present in the mouthpiece or filter element is calculated as a percentage of the total weight of the filtering material and plasticiser via the general equation presented below.

$$Percentage of plasticiser \% = \frac{amount of plasticiser ( g )}{amount of plasticiser ( g ) + amount of filtering material ( g )} \times 100$$

The plasticiser acts to harden the filtering material. Hardening the filtering material may improve the shape definition of the filter element, and in particular the definition of the channel. For example, the filtering material may comprise plasticised fibres, for example plasticised tow, for example plasticised cellulose acetate tow. The plasticiser may be, for example, triacetin, triethyleneglycol diacetate (TEGDA) or polyethylene glycol (PEG). The plasticiser may be applied to the filtering material by spraying onto the surface of the filtering material using methods known in the art.

The layer of additive may comprise a smoke modifying agent, for example a flavouring agent. Examples, of suitable flavouring agents include menthol, spearmint, clove, nutmeg, cinnamon, lemon, chocolate, peach, strawberry, vanilla and the like.

In the case of the additive being a flavouring agent (e.g. menthol), the filter element or mouthpiece may have a flavouring agent loading of from 1 mg per filter element/mouthpiece to 30 mg per filter element/mouthpiece, for example from 2 mg per filter element/mouthpiece to 25 mg per filter element/mouth piece, for example from 2 mg per filter element/mouthpiece to 20 mg per filter element/mouthpiece, for example from 2 mg per filter element/mouthpiece to 10 mg per filter element/mouthpiece, for example from 2 mg per filter element/mouthpiece to 8 mg per filter element/mouthpiece, for example from 4 mg per filter element/mouthpiece to 8 mg per filter element/mouthpiece, for example 6 mg per filter element/mouth piece. The additive may also be dispersed within the longitudinally extending core of filtering material, for example throughout the longitudinally extending core of filtering material.

The outer circumference of the mouthpiece or filter element may be between 14 mm and 27 mm. The channel may for example have a diameter from 0.5 mm to 10 mm, for example from 1 mm to 8 mm, for example from 1 mm to 4 mm, for example from 4 mm to 8 mm, for example from 3 mm to 6 mm.

The length of the mouthpiece or filter element may be between 4.0 mm and 50 mm, for example between 5.0 mm and 40 mm, for example between 10 and 35 mm, for example between 18.0 mm and 30 mm, for example between 22 mm and 28 mm, for example about 25 mm.

The longitudinally extending core of filtering material may be over wrapped with a wrapper or plugwrap, for example a wrapper of paper, for example a wrapper of an air-permeable paper.

The mouth piece or filter element may be for use as part of a tobacco smoke filter or filter for a non-tobacco smokable material, for example marijuana or hemp.

The mouth piece or filter element of the present invention may be incorporated into a smoking article, such as a cigarette, cigarillo, cigar and the like. The mouthpiece or filter element of the present invention may be incorporated into a tobacco heating product or an e-cigarette. The mouth piece or filter element may also be used alone or as part of a filter which is assembled by a user to form a smoking article, for example a roll-your-own smoking article.

In a further aspect of the present invention, there is provided a filter, for example a tobacco smoke filter, comprising a filter element according to the invention.

The filter may comprise an outer wrapper, for example plugwrap, which surrounds the filter element. The wrapper may be paper, for example an air permeable paper. The wrapper may have a weight from 20 to 100 grams per square metre, for example from 20 to 50 grams per square metre, for example from 27 to 35 grams per square metre.

In a further aspect of the present invention there is provided a smoking article comprising a filter, filter element or mouthpiece as described above. The smoking article may include a filter as set out above that is joined to a wrapped rod of smoking material such as tobacco smoking material. Generally, in the case of a smoking article comprising marijuana or hemp smoking material, the smoking article includes a mouth piece according to any statement set out above. The smoking article may further comprise a tipping wrapper, for example a tipping paper. The tipping wrapper joins the wrapped rod of smoking material to the filter or mouthpiece by engaging around the adjacent ends of the filter or mouthpiece and the wrapped rod of smoking material. The tipping wrapper may be configured to leave some of the outer surface of the filter/mouthpiece or filter wrapper exposed. The filter may be joined to the wrapped rod of smoking material by a full tipping wrapper which engages around the full filter or mouthpiece length and the adjacent end of the rod of smoking material.

The mouthpiece, filter element, filter or smoking article according to the invention may be unventilated, or may be ventilated by methods well known in the art, e.g. by use of a pre-perforated or air-permeable filter wrapper (plugwrap) or tipping wrapper (tipping paper), and/or laser perforation of the filter wrapper and/or tipping wrapper. The mouthpiece, filter, filter element or smoking article according to the invention may be ventilated by laser perforation of the longitudinally extending core of filtering material (as well as wrapper(s) (plugwrap) and tipping wrapper (tipping paper) if present). A ventilating full tipping wrapper (tipping paper) may likewise be inherently air-permeable or may be provided with ventilation holes, and for ventilated products where both filter wrapper (plugwrap) and tipping wrapper (tipping paper) are present, ventilation through the tipping wrapper (tipping paper) will usually be in register with that through the filter wrapper (plug wrap). Ventilation holes through a filter wrapper (plugwrap), or through a tipping wrapper (tipping paper), or through both simultaneously, may be made by laser perforation during mouthpiece, filter or filter element production.

In a further aspect of the present invention there is provided a multiple rod comprising a plurality of mouthpieces or filter elements according to the invention arranged end-to-end in a mirror image relationship.

Preferred embodiments of the invention will now be described, by way of example only, with reference to the accompanying drawings in which:

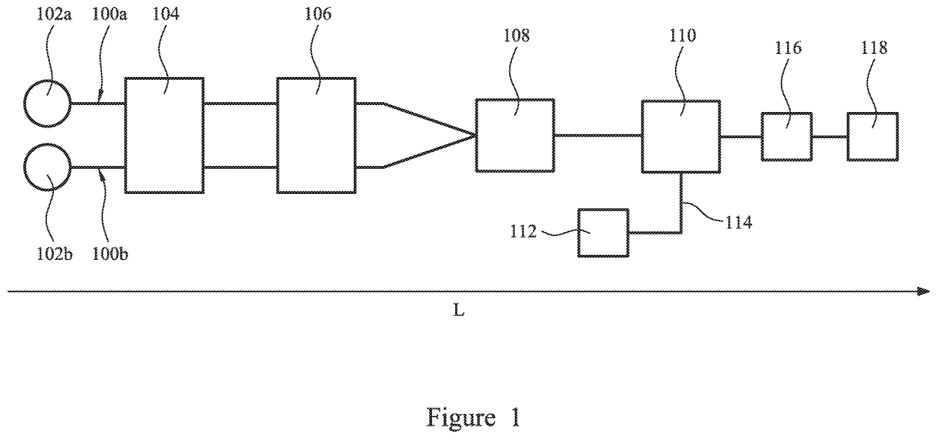

FIG. 1 is a schematic view of the method according to the present invention;

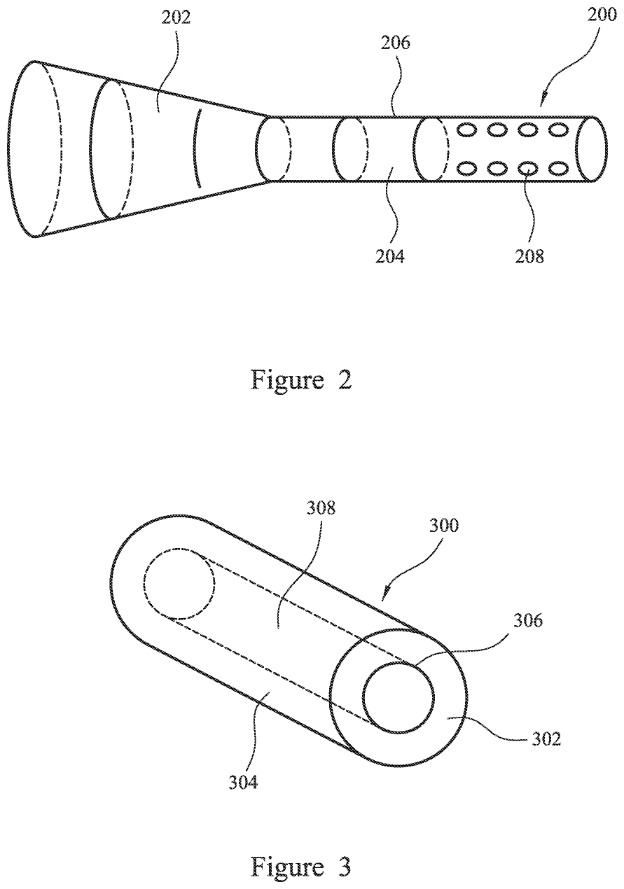

FIG. 2 is a perspective view of a shaping element according to the present invention;

FIG. 3 is perspective view of a filter element or mouthpiece according to the present invention.

FIG. 1 shows a schematic view of a method for making a filter element or mouthpiece according to the present invention.

Filamentary tow 100 is drawn simultaneously from two bales of tow 102a and 102b, and continuously advances in a longitudinal direction L. Each advancing web of tow 100a and 100b is bloomed by a blooming device 104 which spreads out the fibres in a transverse direction. Each web of the transversely spread fibres then enters a plasticising station 106, which sprays plasticiser onto each web of advancing transversely spread fibrous tow to form two webs of plasticised filamentary tow. The plasticiser is sprayed onto the surface of the fibres making up the filamentary tow. The plasticiser is triacetin, although it will be appreciated that other plasticisers may be suitable. The two webs of plasticised filamentary tow are gathered together in a gathering device 108 to form a single web of plasticised filamentary tow. The web of plasticised filamentary tow continues to advance longitudinally and enters a shaping element 110. The shaping element 110 shapes the tow into a longitudinally extending rod of filtering material through which extends a longitudinally extending channel.

The shaping element comprises a hollow cylindrical chamber (die) formed from a metal material such as brass or stainless steel, into which the plasticised tow advances. The chamber has an inner surface which defines a hollow cylinder extending in the longitudinal direction L. The inner surface may have a circumference between 14 mm and 27 mm. As the tow advances into the chamber, the tow is shaped against the inner surface of the chamber to form a longitudinally extending cylindrical rod of filtering material.

The shaping element 110 also includes a mandrel, which is shown in FIGS. 2 and 3. The mandrel extends in the longitudinal direction L within the centre of the chamber.

As shown in FIG. 2, the shaping rod (mandrel) 200 includes a frustoconical section 202 from which extends a cylindrical rod 204. The cylindrical rod 204 having an outer surface 206 and a cavity (not shown). A portion of the cylindrical rod located near to the free end of the cylindrical rod 204 includes a plurality of holes 208 (for example four sets of six equally spaced holes) which extend through the outer surface 206 into the cavity. The plurality of holes are regularly spaced around the entire circumference of the outer surface of the mandrel. The mandrel may be made from any suitable metal, such as brass or stainless steel.

Returning to FIG. 1, as the web of plasticised tow advances into the shaping element 110, the plasticised tow is pressed against the outer surface of the cylindrical rod 204. The cylindrical rod 204 thereby forms a cylindrical channel within the longitudinally extending rod of filtering material. The cylindrical rod 204 being cylindrical means that a substantially cylindrical channel is formed within the rod of filtering material. It will be appreciated that other shaped rods 204 are possible, such as a rod having a triangular, oval or star shaped cross section. The cross sectional shape and diameter of the rod 204 will determine the cross sectional shape and the diameter of the channel formed in the longitudinally extending rod of filtering material. The cylindrical rod 204 may have a diameter from 0.5 mm to 10 mm, for example from 1 mm to 8 mm, for example from 1 mm to 4 mm, for example from 4 mm to 8 mm, for example from 3 mm to 6 mm.

The mandrel 200 may be aligned centrally within the chamber of the shaping element 110. Central alignment of the mandrel 200 will mean that the channel formed in the longitudinally extending rod is positioned centrally within the longitudinally extending rod of filtering material.

It is possible for the mandrel 200 to include more than one cylindrical rod 204, for example two, three, or four cylindrical rods, which will thereby form multiple channels in the rod of filtering material. In such a configuration, the mandrel may include two, three or four pins which protrude longitudinally to thereby enable two, three or four channels to form in the filtering material.

The mandrel 200 additionally applies an additive, in the form of a menthol composition, to the continuously advancing filtering material. Additive is pumped from an external reservoir 112 and is carried by a pipe 114 to the mandrel. The pipe 114 connects to the frustoconical section 202 of the mandrel 200. The additive passes through the cavity within the mandrel and exits the mandrel through the plurality of holes 208. As the additive exits the holes 208, the additive forms a spray. The additive spray is directed towards the filtering material, and the additive penetrates throughout the filtering material. The additive may also form a layer on the inner surface of the filtering material that defines the channel.

As set out above, the plurality of holes extend around the entire circumference of the cylindrical rod 204 which means that the additive can be applied in many directions, so that the additive is applied throughout the filtering material.

The menthol composition includes menthol and a solvent such as propylene glycol. It will be appreciated that the menthol composition could also include pure menthol without a solvent.

Superheated steam is applied directly to the filtering material within the shaping element chamber via steam inlet pipes which pass through the exterior of the shaping element. Superheated steam acts to cure the plasticised filtering material as it is shaped by the shaping element. The curing hardens the filtering material such that the shape of the rod of filtering material and the channel shape are well defined. The superheated steam is applied directly to the outer surface of the longitudinally extending rod of filtering material as it is formed by the shaping element chamber.

Surprisingly, the applicant has found that despite the presence of steam in the shaping element, high menthol loadings can be achieved and the menthol remains incorporated in the filtering material over time, as is demonstrated in examples 1 and 2.

After the longitudinally extending rod of filtering material exits the shaping element, the rod continues to advance and is cooled by jets of air 116 and is cut by a rotary cutter 118 to form filter elements or mouthpieces.

Before being cut, the longitudinally extending rod of filtering material may be wrapped with a paper wrapper.

The filter elements or mouthpieces may be assembled into a multiple rod comprising a plurality of filter elements or mouth pieces joined end to end in a mirror image relationship.

The filter elements or mouthpieces may be assembled into a smoking article using techniques well known in the art.

FIG. 3 is a perspective view of a filter element or mouthpiece according to the invention.

The filter element or mouthpiece 300 shown in FIG. 3 may be made by the method described above.

The filter element or mouthpiece 300 comprises a longitudinally extending core 302 of filtering material wherein the longitudinally extending core 302 has an outer surface 304 and an inner surface 306. The filtering material comprises cellulose acetate filamentary tow and a plasticiser such as triacetin. The filter element or mouthpiece also includes a channel 308 which extends from an end of the core, the channel being defined by the inner surface of the core. The channel includes a layer of menthol disposed on the inner surface of the core. The core 302 also includes menthol which is dispersed throughout the filtering material. The filter element or mouth piece includes menthol in an amount of around 6 mg per filter element/mouthpiece

The filter element or mouthpiece 300 may form part of a smoke filter suitable for a tobacco smoking article or non-tobacco smokable material such as marijuana or hemp. Additionally, the filter element or mouthpiece may be used in heat not burn or e-cigarette type devices.

### EXAMPLES

### Example 1

Filter elements were made according to the process described above and illustrated in FIG. 1.

The filter elements included a longitudinally extending core of cellulose acetate filamentary tow having an inner surface and an outer surface, in which the inner surface defines a cylindrical channel which extends from an end of the filter element. The core was formed from two bales of cellulose acetate tow having denier 5.0Y30.

The filtering material included menthol which was applied according to the method of the invention. The menthol was applied as a liquid solution which included menthol and propylene glycol. The filtering material included triacetin as a plasticiser in an amount of 19.7% by total weight of the filtering material and plasticiser, which was applied according to the process of the invention. The cylindrical channel had a diameter of 5 mm. The filter element had a length of 120 mm.

The filtering elements were analysed in ten batches. Each batch included 4520 filter elements. From each batch, five multi segment filters were assembled, each having 6 filter elements. The five multisegment filters from each batch were analysed using gas chromatography and the menthol loading was measured over the course of 32 days. Average menthol loadings were calculated based on the measurements in each batch at each time point. Additionally, the filter circumference of 10 multisegment filters from each batch was measured using a quality testing machine (QTM3 (laser gauge) Cerulean). The results are set out in table 1 below.

TABLE 1

| | Average menthol loading | Circumference |
|---|---|---|
| Day | (g per 100 filters) | (mm) |
| 1 | 2.54 | 24.50 |
| 7 | 2.66 | 24.53 |
| 11 | 2.62 | 24.49 |
| 14 | 2.79 | 24.47 |
| 21 | 2.49 | 24.50 |
| 25 | 2.58 | 24.47 |
| 32 | 2.54 | 24.48 |

As shown in table 1, the tested filters include a high and desirable menthol loading on day 1 which was above the target loading of 2.52. The menthol loading stayed fairly constant until day 32 and no significant decrease in menthol loading was observed.

Circumference also stayed constant between day 1 and 32, and no significant circumference growth was observed.

### Example 2

Filter elements were made according to the process described above and illustrated in FIG. 1.

The filter elements included a longitudinally extending core of cellulose acetate filamentary tow having an inner surface and an outer surface, in which the inner surface defines a star shaped channel which extends from an end of the filter element. The core was formed from two bales of cellulose acetate tow having denier 5.0Y30.

The filtering material included menthol which was applied according to the method of the invention. The menthol was applied as a liquid solution which included menthol and propylene glycol. The filtering material included triacetin as a plasticiser in an amount of 19.7% by total weight of the filtering material and plasticiser, which was applied according to the process of the invention. The cylindrical channel had a diameter of 5 mm. The filter element had a length of 120 mm.

The filtering elements were analysed in ten batches. Each batch included 4520 filter elements. From each batch, five multi segment filters were assembled each having 6 filter elements. The five multisegment filters from each batch were analysed using gas chromatography and the menthol loading was measured over the course of 32 days. Average menthol loadings were calculated based on the measurements in each batch at each time point. Additionally, the filter circumference of 10 filter elements from each batch was measured using a quality testing machine (QTM3 (laser gauge) Cerulean). The results are set out in table 2 below.

TABLE 2

| | Average menthol loading | Circumference |
|---|---|---|
| Day | (g per 100 filters) | (mm) |
| 1 | 2.51 | 24.56 |
| 2 | 2.60 | 24.63 |
| 8 | 2.54 | 24.60 |
| 12 | 2.57 | 24.58 |
| 15 | 2.64 | 24.57 |
| 22 | 2.44 | 24.57 |
| 26 | 2.65 | 24.57 |
| 33 | 2.49 | 24.58 |

As shown in table 2, the tested filters include a high and desirable menthol loading on day 1. The menthol loading stayed fairly constant until day 33 and no significant decrease in menthol loading was observed.

Circumference also stayed constant between day 1 and 33, and no significant circumference growth was observed.

1. A method of making a filter element or mouthpiece comprising the steps of:
advancing filtering material in a longitudinal direction;
and
drawing the advancing filtering material into a shaping element, to thereby form a longitudinally extending rod of filtering material comprising a channel extending longitudinally through the rod of filtering material;
wherein the shaping element comprises a chamber and a shaping rod which extends longitudinally within the chamber, an inner surface of the chamber shaping the advancing filtering material to form the longitudinally extending rod of filtering material, and the shaping rod shaping the advancing filtering material to form the channel extending longitudinally through the rod of filtering material; and
wherein the shaping element applies an additive to the advancing filtering material.

2. The method according to claim 1, wherein the shaping rod applies the additive to the advancing filtering material.

3. The method according to claim 1, wherein the shaping rod comprises a cavity and a plurality of holes which are coupled to the cavity, wherein the additive travels from the cavity and exits the shaping rod through the plurality of holes as the advancing filtering material passes through the shaping element.

4. The method according to claim 1, wherein the shaping rod comprises an outer surface which defines a shape of the channel extending longitudinally through the rod of filtering material.

5. The method according to claim 3, wherein the additive is a liquid.

6. The method according to claim 5, wherein the additive forms a spray as the additive exits the plurality of holes.

7. The method according to claim 1, wherein a plasticiser is applied to the advancing filtering material.

8. The method according to claim 7, wherein the plasticiser is applied to the advancing filtering material before the advancing filtering material is drawn into the shaping element.

9. The method according to claim 1, wherein steam is applied to the advancing filtering material as the advancing filtering material passes through the shaping element.

10. The method according to claim 9, wherein the steam is applied directly to the advancing filtering material within the shaping element.

11. The method according to claim 9, wherein the steam is applied directly to an outer surface of the longitudinally extending rod of filtering material as the longitudinally extending rod of filtering material forms within the shaping element.

12. The method according to claim 1, further comprising cutting the longitudinally extending rod of filtering material to form the filter element or mouthpiece.

13. The method according to claim 1, wherein the additive is a smoke or aerosol modifying agent.

14. The method according to claim 13, wherein the additive is a flavouring agent.

15. The method according to claim 14, wherein the flavouring agent is one or more of menthol, spearmint, clove, nutmeg and cinnamon.

16. A filter element or mouthpiece formed by the method according to claim 1.

17. A shaping rod for use in a method of making a filter element or mouthpiece comprising:
a longitudinal rod comprising a cavity and an outer surface;
a plurality of holes located in the outer surface of the longitudinal rod, wherein the plurality of holes are coupled to the cavity.

18. The shaping rod according to claim 17, wherein the plurality of holes extend from the outer surface to the cavity.

19. An apparatus for making a filter element or mouthpiece, the apparatus comprising:
a shaping element comprising a chamber and the shaping rod according to claim 17, wherein the shaping rod extends longitudinally within the chamber.

20. The apparatus according to claim 19, wherein the chamber comprises one or more steam inlets.

21. The apparatus according to claim 20, wherein the one or more steam inlets are configured to apply steam to filtering material within the chamber.

22. The apparatus according to claim 19, wherein, in use, the shaping rod is configured to apply a flavouring agent to filtering material within the chamber.

23. A filter element or mouthpiece comprising:
a longitudinally extending core of filtering material, wherein the longitudinally extending core of filtering material has an outer surface and an inner surface;
a channel extending from an end of the core, wherein the channel is defined by the inner surface of the core;
a layer of additive disposed on the inner surface of the core.

24. The filter element or mouthpiece according to claim 23, wherein the additive is a smoke or aerosol modifying agent.

25. The filter element or mouthpiece according to claim 24, wherein the additive is a flavouring agent.

26. A filter comprising the filter element according to claim 16.

27. A multiple rod comprising a plurality of mouthpieces or filter elements according to claim 16 joined end-to-end in a mirror image relationship.

28. A smoking article comprising a mouthpiece or filter element according to claim 16, the mouthpiece or filter element being joined to a rod of smokable material.
